(19) United States
(12) Patent Application Publication
(10) Pub. No.: US 2015/0341223 A1
(43) Pub. Date: Nov. 26, 2015

(54) AUTOMATIC PLACEMENT OF CLIENTS IN A DISTRIBUTED COMPUTER SYSTEM BASED ON AT LEAST PHYSICAL NETWORK TOPOLOGY INFORMATION

(71) Applicant: Nicira, Inc., Palo Alto, CA (US)

(72) Inventors: Jianjun Shen, Beijing (CN); Hua Wang, Beijing (CN); James J. Stabile, Los Altos, CA (US)

(73) Assignee: NICIRA, INC., Palo Alto, CA (US)

(21) Appl. No.: 14/284,286

(22) Filed: May 21, 2014

(51) Int. Cl. H04L 12/24

(52) U.S. Cl. CPC H04L 41/12

(57) ABSTRACT

A management server and method for performing automatic placement of clients in a distributed computer system selects final client placement locations to place the clients from candidate client placement locations, where the placement requirements of the clients can be satisfied, based on at least physical network topology information of the distributed computer system.

### BACKGROUND

Resource-consuming clients, such as virtual machines (VMs) or other software entities capable of running various applications, can be used to deploy applications in one or more virtual datacenters, which are collections of computing, storage, and networking resources that may be supported in a distributed computer system. In order to ensure that the applications perform well for their intended purposes, the clients that run the applications should be strategically placed on host devices of the distributed computer system. Various algorithms have been developed for placing clients on proper host devices.

The main goal of any client placement algorithm is to place a client in a host device where its requirements of various physical resources, such as computation, storage and network resources, can be satisfied so that these resources can be scheduled to the client on demand. Client placement algorithms may involve initial placements when the clients are first deployed and also subsequent dynamic placement adjustments at runtime.

### SUMMARY

A management server and method for performing automatic placement of clients in a distributed computer system selects final client placement locations to place the clients from candidate client placement locations, where the placement requirements of the clients can be satisfied, based on at least physical network topology information of the distributed computer system.

A method for performing automatic placement of clients in a distributed computer system in accordance with an embodiment of the invention comprises receiving placement requirements of the clients, receiving physical network topology information of the distributed computer system, determining candidate client placement locations in the distributed computer system where the placement requirements of the clients can be satisfied, and selecting final client placement locations to place the clients from the candidate client placement locations based on at least the physical network topology information of the distributed computer system. In some embodiments, the steps of this method are performed when program instructions contained in a computer-readable storage medium is executed by one or more processors.

A management server for a distributed computer system in accordance with an embodiment of the invention comprises a processor, and a client placement engine that, when executed by the processor, performs steps comprising receiving placement requirements of the clients, receiving physical network topology information of a distributed computer system, determining candidate client placement locations in the distributed computer system where the placement requirements of the clients can be satisfied, and selecting final client placement locations to place the clients from the candidate client placement locations based on at least the physical network topology information of the distributed computer system.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a distributed computer system in accordance with an embodiment of the invention.

FIG. 2 is a block diagram of a host computer in accordance with an embodiment of the invention.

FIG. 3 is a diagram of a physical network topology graph in accordance with an embodiment of the invention.

FIG. 4 is a flow diagram of a method for performing automatic placement of clients in a distributed computer system in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

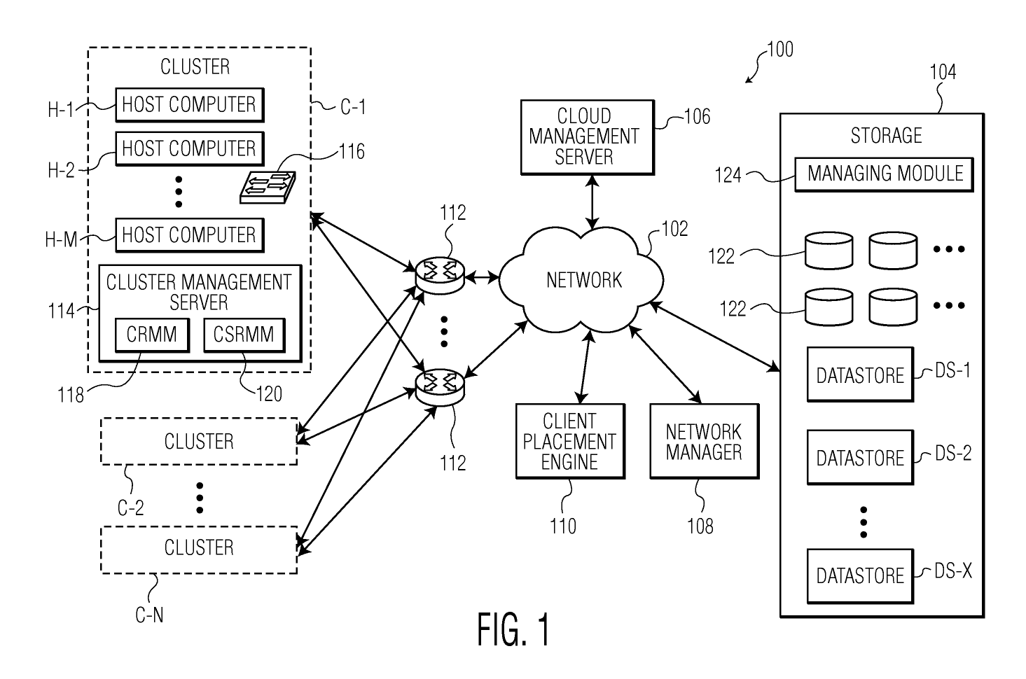

Turning now to FIG. 1, a distributed computer system 100 in accordance with an embodiment of the invention is shown. As shown in FIG. 1, the distributed computer system includes a network 102, clusters C-1, C-2 . . . C-N (where N is a positive integer) of host computers, storage 104, a cloud management server 106, a network manager 108 and a client placement engine 110. Cloud management server 106, network manager 108, and client placement engine 110 may be software server applications that execute on one or more computers (not shown) or virtual machines on hosts (not shown) directly connected as shown, or indirectly connected (not shown) to network 102, or as clients within one of clusters C-1 . . . C-N. As described in more detail below, the client placement engine operates to make recommendations regarding initial placements of clients in the distributed computer system and subsequent placements or relocations of clients in the distributed computer system. As used herein, the term “client” is any software entity that can run on a computer system, such as a software application, a software process or a virtual machine (VM). The client placement engine makes client placement recommendations based on common client placement parameters, such as virtualized resource requirements (e.g., compute, storage and network resources) and policy requirements of the clients, as well as additional information regarding physical network topology, virtual network topology, user-provided client communication relationships and/or runtime-collected client communication relationships. The additional information allows the client placement engine to make client placement recommendations that can shorten communication paths between the clients, increase performance of the clients and reduce cost with respect to resource usage.

As shown in FIG. 1, the distributed computer system 100 includes a number of clusters C-1, C-2 . . . C-N of host computers. The clusters may be connected to the network 102 and other components of the distributed computer system via network routers 112. The cloud management server 106 and the client placement engine 110 are also connected to the network 102 either directly or via one or more network components, such as hubs, routers and switches.

In the illustrated embodiment, each of the clusters C-1, C-2 . . . C-N includes a number of host computers H-1, H-2 . . . H-M (where M is a positive integer) and a cluster management server 114. The number of host computers included in each of the clusters can be any number from one to several hundred or more. In addition, the number of host computers included in each of the clusters can vary so that different clusters can have a different number of host computers. The host computers are physical computer systems that host or support one or more clients so that the clients are executing on the physical computer systems. The host computers may be servers that are commonly found in datacenters. As an example, the host computers may be servers installed in one or more server racks. In an embodiment, the host computers of a cluster are located within the same server rack. The host computers in the same clusters may be connected to each other via one or more switches 116, which may be connected to at least one of the routers 112. Thus, each of the host computers in the clusters is able to access any component in the distributed computer system 100 via the network. In particular, each of the host computers in the clusters is able to access the storage 104 via the network and may share the resources provided by the storage with the other host computers. Consequently, any client running on any of the host computers may also access the storage via the network.

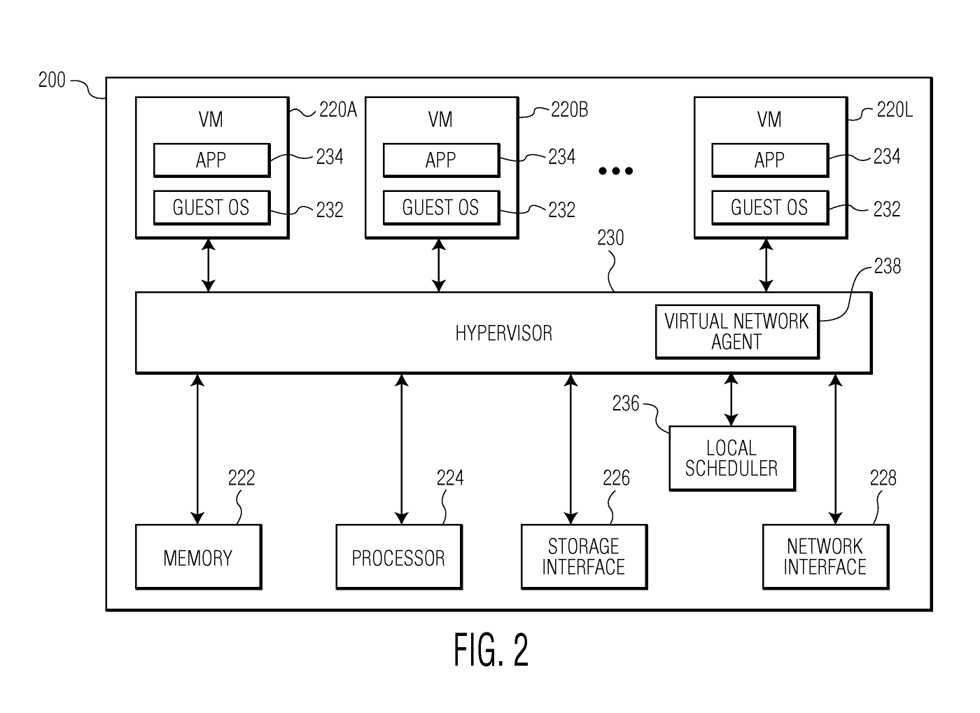

Turning now to FIG. 2, components of a host computer 200 that is representative of the host computers H-1, H-2 . . . H-M in accordance with an embodiment of the invention are shown. In FIG. 2, the physical connections between the various components of the host computer are not illustrated. In the illustrated embodiment, the host computer is configured to support a number of clients 220A, 220B . . . 220L (where L is a positive integer), which are VMs. The number of VMs supported by the host computer can be anywhere from one to more than one hundred. The exact number of VMs supported by the host computer is only limited by the physical resources of the host computer. The VMs share at least some of the hardware resources of the host computer, which include system memory 222, one or more processors 224, a storage interface 226, and a network interface 228. The system memory 222, which may be random access memory (RAM), is the primary memory of the host computer. The processor 224 can be any type of a processor, such as a central processing unit (CPU) commonly found in a server. The storage interface 226 is an interface that allows that host computer to communicate with the storage 104. As an example, the storage interface may be a host bus adapter or a network file system interface. The network interface 228 is an interface that allows the host computer to communicate with other devices connected to the network 102. As an example, the network interface may be a network adapter.

In the illustrated embodiment, the VMs 220A, 220B . . . 220L run on “top” of a hypervisor 230, which is a software interface layer that, using virtualization technology, enables sharing of the hardware resources of the host computer 200 by the VMs. However, in other embodiments, one or more of the VMs can be nested, i.e., a VM running in another VM. Any computer virtualization architecture can be implemented. For example, the hypervisor may run on top of the host computer's operating system or directly on hardware of the host computer. With the support of the hypervisor, the VMs provide isolated execution spaces for guest software. Each VM may include a guest operating system 232 and one or more guest applications 234. The guest operating system manages virtual system resources made available to the corresponding VM by hypervisor 230, and, among other things, guest operating system 234 forms a software platform on top of which guest applications 234 run.

Similar to any other computer system connected to the network 102, the VMs 220A, 220B . . . 220L are able to communicate with each other using an internal software OSI Layer 2 switch (not shown) and with other computer systems connected to the network using the network interface 228 of the host computer 200. In addition, the VMs are able to access the storage 104 using the storage interface 226 of the host computer.

The host computer 200 also includes a local scheduler 236 that operates as part of a resource management system, such as VMware vSphere® Distributed Resource Scheduler™ (DRS) (“VMware vSphere” and “Distributed Resource Scheduler” are trademarks of VMware, Inc.), to manage resource requests made by the VMs 220A, 220B . . . 220L. Although the local scheduler is illustrated in FIG. 2 as being separate from the hypervisor 230, the local scheduler may be implemented as part of the hypervisor. In some embodiments, the local scheduler is implemented as one or more software programs running on the host computer. However, in other embodiments, the local scheduler may be implemented using any combination of software and hardware.

In the illustrated embodiment, the host computer 200 further includes a virtual network agent 238. The virtual network agent operates with the hypervisor 230 to provide virtual networking capabilities, such as bridging, L3 routing, L2 Switching and firewall capabilities, so that software defined networks or virtual networks can be created. In a particular embodiment, the virtual network agent may be part of a VMware NSX™ virtual network product installed in the distributed computer system 100 (“VMware NSX” is a trademark of VMware, Inc.).

Turning back to FIG. 1, each of the cluster management servers 114 in the clusters C-1, C-2 . . . C-N operates to monitor and manage the host computers H-1, H-2 . . . H-M in the respective cluster. Each cluster management server may be configured to monitor the current configurations of the host computers and the clients, e.g., VMs, running on the host computers in the respective cluster. The monitored configurations may include hardware configuration of each of the host computers, such as CPU type and memory size, and/or software configurations of each of the host computers, such as operating system (OS) type and installed applications or software programs. The monitored configurations may also include client hosting information, i.e., which clients are hosted or running on which host computers. The monitored configurations may also include client information. The client information may include size of each of the clients, virtualized hardware configuration of each of the clients, such as virtual CPU type and virtual memory size, software configuration of each of the clients, such as OS type and installed applications or software programs running on each of the clients, and virtual storage size for each of the clients. The client information may also include resource parameter settings, such as demand, limit, reservation and share values for various resources, e.g., CPU, memory, network bandwidth and storage, which are consumed by the clients. The “demand,” or current usage, of the clients for the consumable resources, such as CPU, memory, network, and storage, are measured by the host computers hosting the clients and provided to the respective cluster management server.

The cluster management servers 114 may also perform various operations to manage the clients and the host computers H-1, H-2 . . . H-M in their respective clusters. As illustrated in FIG. 1, in an embodiment, each cluster management server includes a cluster resource management module (CRMM) 118, which can be enabled by a user, to perform resource allocations and load balancing in the respective cluster. The cluster resource management module operates to allocate available resources among clients running in the cluster based on a number of parameters, which may include predefined rules and priorities. The cluster resource management module may be configured to power down particular clients and/or host computers in the cluster to conserve power. The cluster resource management module may further be configured or programmed to perform other operations to manage the cluster. Each cluster management server may also include a cluster storage resource management module (CSRMM) 120, which can be enabled by a user, to perform storage resource management for the respective cluster. The cluster storage resource management module enables client disk placements (e.g., VM disk placements) and migrations to balance space and I/O resources across datastores that are associated with the cluster via recommendations or automated operations.

In some embodiments, the cluster management servers 114 may be physical computers with each computer including at least memory and one or more processors, similar to the host computer 200. In other embodiments, the cluster management servers may be implemented as software programs running on physical computers, such as the host computer 200 shown in FIG. 2, or virtual computers, such as the VMs 220A, 220B . . . 220L. In an implementation, the cluster management servers are VMware® vCenter™ servers with at least some of the features available for such servers (“VMware” and “vCenter” are trademarks of VMware, Inc.), the cluster resource management modules 118 in the cluster management servers are VMware vSphere® Distributed Resource Schedulers™, and the cluster storage resource management modules 120 in the cluster management servers are VMware® Storage Distributed Resource Scheduler™ (“Storage Distributed Resource Scheduler” is a trademark of VMware, Inc.).

The network 102 can be any type of computer network or a combination of networks that allows communications between devices connected to the network. The network 102 may include the Internet, a wide area network (WAN), a local area network (LAN), a storage area network (SAN), a Fibre Channel network and/or other networks. The network 102 may be configured to support protocols suited for communications with storage arrays, such as Fibre Channel, Internet Small Computer System Interface (iSCSI), Fibre Channel over Ethernet (FCoE) and HyperSCSI.

The storage 104 is used to store data for the host computers of the clusters C-1, C-2 . . . C-N, which can be accessed like any other storage device connected to computer systems. The storage includes one or more computer data storage devices 122. The storage includes a storage managing module 124, which manages the operation of the storage. The storage supports multiple datastores DS-1, DS-2 . . . DS-X (where X is a positive integer), which may be identified using logical unit numbers (LUNs).

The cloud management server 106 operates to monitor and manage the clusters C-1, C-2 . . . C-N to provide a cloud environment using the host computers H-1, H-2 . . . H-M in the clusters. The cloud management server allows users or customers to create and use virtual datacenters (VDCs) with specified resource requirements. One VDC may include clients running on different host computers that are part of different clusters. Thus, in a single cluster, a group of clients running on the host computers of that cluster may belong to one VDC, while the other clients running on the host computers of the same cluster may belong to other VDCs. It is also possible that, in a single host computer, one or more clients running on that host computer belong to one VDC, while the other clients running on the same host computer belong to other VDCs. The cloud management server 106 performs operations to manage the VDCs supported by the distributed computer system. In some embodiments, the cloud management server may be a physical computer. In other embodiments, the cloud management server may be implemented as a software program running on a physical computer or a VM, which may be part of one of the clusters C-1, C-2 . . . C-N. In an implementation, the cloud management server is a server running VMware® vCloud Director® product (“vCloud Director” is a registered trademark of VMware, Inc.).

Virtual networks, also referred to as logical overlay networks, comprise logical network devices and connections that are then mapped to physical networking resources in a manner analogous to the manner in which other physical resources as compute and storage are virtualized. The network manager 108 operates to manage and control the virtual networks in the distributed computer system 100. In an embodiment, the network manager has access to information regarding the physical network components in the distributed computer system, such as the host computers H-1, H-2 . . . H-M, the switches 116 and the routers 112, and virtual network configurations, such as VMs, and the logical network connections between them. With the physical and virtual network information, the network manager may map the logical network configurations, e.g., logical switches, routers, and security devices to the physical network components that convey, route, and filter physical traffic in the distributed computer system. The network manager may provide a graphic user interface (GUI) to present physical and virtual network information to a user. The GUI may allow the user to control different aspects of the virtual network topology in the distributed computer system. In one particular implementation, the virtual network manager is a VMware NSX™ manager running on a physical computer in the distributed computer system.

Client placement engine 110 determines initial placements of new clients at the time of deployment in the distributed computer system 100 and subsequent placements, migrations, or relocations of the clients during runtime. In order to determine client placement locations in the distributed computer system for new or existing clients, the client placement engine executes a placement algorithm to analyze possible placement locations in the distributed computer system that can satisfy resource and policy requirements of the clients. In addition, the placement algorithm takes into consideration information related to quality of service of physical interconnectivity in the distributed computer system to make client placement location recommendations. In some embodiments, a client placement location in the distributed computer system is a particular host computer or a particular cluster of host computers. However, in other embodiments, a client placement location can be any physical subset of the distributed computer system or any virtual or logical location supported by the distributed computer system. In addition, as used herein, information related to quality of service of physical interconnectivity in the distributed computer system includes information that affects (either reduces or increases) quality of service of the physical interconnectivity in the distributed computer system. The information related to quality of service of physical interconnectivity in the distributed computer system includes, but not limited to, (a) physical network topology of the distributed computer system, (b) virtual network topology of the distributed computer system and (c) client communication relationships.

The physical network topology of the distributed computer system 100 can affect the quality of service of the physical interconnectivity in the distributed computer system because performance and cost of communications between different physical network segments of the distributed computer system can vary. Thus, the physical network topology of the distributed computer system is an important consideration for placement of clients in the distributed computer system. If physical network segments of the distributed computer system can be defined based on communication performance and cost, these segments can be used by the client placement engine 110 to place clients that communicate frequently with each other in close physical proximity to increase communication performance and decrease communication cost.

In an embodiment, the physical network segments of the distributed computer system 100 are defined so that communication performance is relatively high and communication cost is relatively low for communications within a segment, when compared to communications across segments. In addition, the segments of the distributed computer system are defined so that communication performance is relatively high and communication cost is relatively low for communications between two segments in close physical proximity to one another or connected by only one or several network nodes, such as L2 or L3 devices, compared to communication between two segments that are separated by large relative physical distances or by a larger number of network nodes. Segments may be nested, and each segment may include multiple sub-segments. There can be different types of segments, such as: (1) single hypervisor segments; (2) physical virtual local area network (VLAN) or subnet segments; (3) subnet group segments; and (4) datacenter segments.

A single hypervisor segment is defined by a segment where communications between clients go through a single hypervisor or a single virtual switch without having to leave the hypervisor and go out to the physical network. Thus, a single hypervisor segment can be viewed as a single host computer. This segment is the smallest segment unit.

A VLAN or subnet segment is defined by a VLAN or a subnet, which comprises multiple single hypervisor segments. In this segment, communications inside the segment do not need to go through routers. If the segment is a group of hypervisors under a single access/top-of-rack (ToR) switch, communications do not need to leave the switch/rack.

A subnet group segment is defined by a group of adjacent subnets that have high bandwidth between each other. Thus, communication performance within this segment will be high.

A datacenter segment is defined by network components that form a physical datacenter. Communications within a datacenter segment is typically better than communications across datacenters.

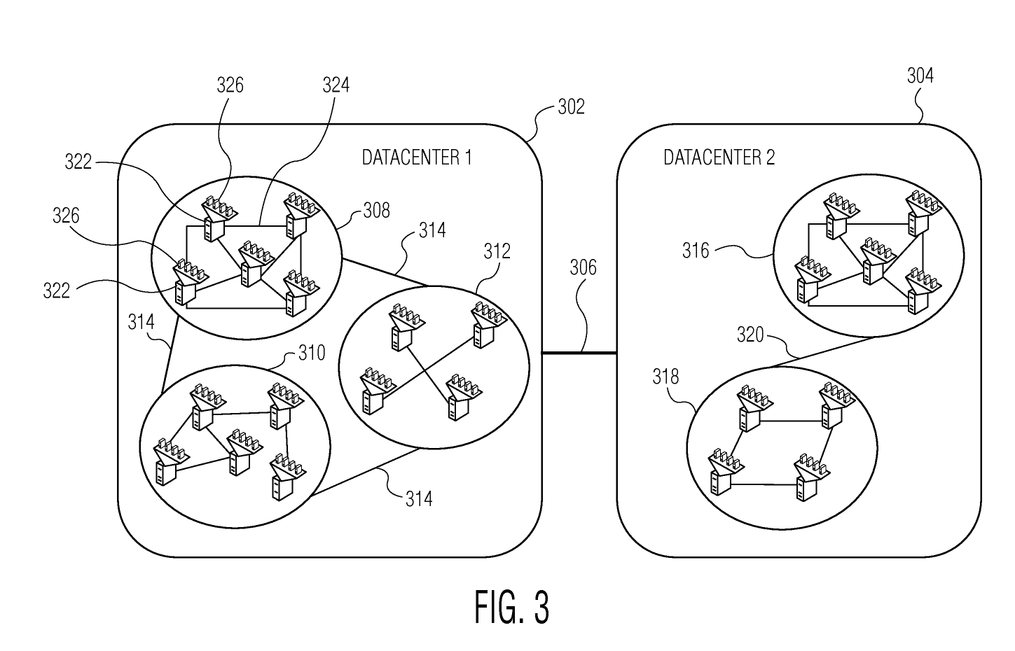

In an embodiment, the physical network topology of the distributed computer system 100, including the different types of segments, is gathered by the network manager 108 and provided to the client placement engine 110. For some segments types, such as the hypervisor segments and the VLAN or subnet segments, the scope of a segment can be derived from hypervisors' network configuration. Thus, the network manager may be configured to periodically retrieve this information from the hypervisors of the host computers in the distributed computer system. For other segments types, the network manager may run a network topology discovery protocol on the hypervisors to discover the scope of those segments. The physical network topology information of the distributed network system may be defined as a graph that includes nested segments. Optionally, the physical network topology information of the distributed network system may further include network parameters that are associated with links between two adjacent segments or links between sub-segments and their direct super segments, including performance parameters (e.g., throughput and latency) and cost parameters. An example of the physical network topology graph is shown in FIG. 3.

The physical network topology graph of FIG. 3 shows two datacenter segments 302 and 304 that are connected to each other by a communication link 306. The physical network topology graph further shows three subnets/racks 308, 310 and 312 in the datacenter segment 302 that are connected to each other by communication links 314. Similarly, two subnets/racks 316 and 318 are shown in the datacenter segment 304 that are connected to each by a communication link 320. In each of the subnets/racks, there are multiple host computers 322 that are connected to each other by communication links 324. Each host computer supports a number of clients 326, e.g., VMs.

The virtual network topology of the distributed computer system 100 can also affect the quality of service of the physical interconnectivity in the distributed computer system, and thus is another important consideration for placement of clients in the distributed computer system. For example, Virtual Extensible LAN (VXLAN) is a network virtualization technology that can create virtual layer 2 networks that each span multiple physical layer 3 networks using network packet encapsulation. Since network packets can be encapsulated and decapsulated, clients can be deployed to such a virtual layer 2 network without being configured for the underlying physical network. A VXLAN backed virtual layer 2 network can span across multiple physical VLANs or physical network segments, and even multiple physical datacenters. Virtual routing may be supported between two virtual layer 2 network segments. With distributed routing implemented by hypervisors (e.g., VMware NSX™ distributed logical routing), one-hop routing of client traffic may be supported so that cross-subnet traffic between clients could be forwarded by the source hypervisor directly to the destination hypervisor (e.g., through VXLAN tunnels) without going through intermediate routers in the virtual networks. Thus, knowledge of the virtual network topology of the distributed computer system, along with knowledge of the physical network topology, clients may be placed in virtual networks with consideration of the physical location of the clients.

Client communication relationships are also important considerations for placement of clients in the distributed computer system 100. Client communication relationships are defined by communication parameters between clients including, but not limited to, (a) communication frequency between the clients, (b) type of traffic between the clients, (c) traffic throughput between the clients, and (d) communication latency and other performance requirements (e.g., packet loss rate) between the clients. The communication parameters may also include whether the communications between the clients are unicast or multicast communications. When distributed routing of client traffic is supported, both layer 2 and layer 3 communication information can be used to define client communication relationships. Otherwise, if distributed routing is not supported, only layer 2 communication may be used to define client communication relationships since consideration of multi-hop routing relationship will add significant complexity. When two clients or a group of clients communicate with each other frequently, in high throughput, and/or have high performance requirements, these clients are defined as having close communication relationships. In addition, other relationships between clients may be used to define the communication relationships between them. For example, clients belonging to the same tenant, e.g., in a cloud system, may want to be placed closer to other clients of the same tenant since there may be significant communications between them. However, in some situations, clients belonging to the same tenant may want to be placed farther away from other clients of the same tenant, e.g., to provide high availability.

Some or all of the client communication relationship information may be provided by a user or creator of clients as expected communication relationships or communication performance requirements between the clients (e.g., throughput, latency and packet loss rate requirements). Some or all of the client communication relationship information may be dynamically collected during runtime. This runtime information may provide the client communication relationship information not provided by the user or creator, or may supplement or update the client communication relationship information provided by the user or creator. The runtime information may be provided by the hypervisors in the host computers, each of which collects network communication states of its clients. Thus, the network communication states of the entire network, i.e., the distributed computer system 100, can be acquired by gathering the network communication states from the hypervisors and consolidating the network communication states at network manager 108 or other entity.

In an embodiment in which VMware NSX™ is installed in the distributed computer system 100, each hypervisor is connected to a centralized controller or cluster of controllers (“control cluster”), which maintains global virtual network views. The logical switch and logical router implementation on a hypervisor can collect bidirectional layer 2 and layer 3 network communication statistics between two local clients or between a local client and a remote client, and report the statistics to the control cluster. A remote client can be identified by an identifier, such as local network identification or IP/MAC address, in the report. With the statistics report from each of the hypervisors, the control cluster can build a global view of client communication relationships. In this embodiment, the network manager 108 may be the centralized control cluster or include the centralized control cluster.

However, in other embodiments, the network communication statistics between various clients in the distributed computer system 100 may be collected by the hypervisors, which are then gathered and consolidated by other components in the distributed computer system, such as the cloud management server 106.

The client placement engine 110 uses the information that affects quality of service of the physical interconnectivity, e.g., the physical topology, the virtual network topology and the client communication relationships, along with client requirements, e.g., virtualized resource requirements and policy requirements, to make client placement recommendations, which may be recommendations for initial client placements or recommendations for subsequent client placements or migrations. The client placement engine may be designed to make client placement recommendations within a single cluster of host computers or across multiple clusters of host computers.

In one application, the client placement engine 110 may operate on the cloud environment provided by the clusters C-1, C-2 . . . C-N, as a cloud or multicluster-level client placement engine. Thus, the client placement engine may be part of a cloud management system. As an example, the client placement engine may be incorporated into a VMware® vCloud Director® product. In this application, for each client to be placed, the client placement engine executes a client placement algorithm to select a placement cluster from a list of candidate clusters, which are determined to satisfy resource and policy requirements of the client. The list of candidate clusters may be determined by the client placement engine or provided by other components that cooperate with the client placement engine. In an implementation, the list of candidate clusters is generated by compute, storage, network and policy based management (PBM) fabric components (not shown) of the cloud management server 106. These fabric components operate to aggregate and manage the various resources in the distributed computer system 100. The compute fabric component aggregates the compute resources, e.g., the CPU and RAM resources, in the distributed computer system and manages these resources. The storage fabric component aggregates the storage resources in the distributed computer system and manages these resources. The network fabric component aggregates the network resources, i.e., network bandwidth, in the distributed computer system and manages these resources. The PBM fabric component aggregates policies in the distributed computer system and manages these resources. One of the policies may be the storage class for a virtual disk of a VM. For example, a datastore can be one of three user-defined storage classes: gold, silver and bronze. Other policies may include VM to VM affinity and anti-affinity policies. These rules can be at host level or at cluster level. A host level anti-affinity policy between two VMs will ensure that both VMs will be placed on different hosts. A host level affinity policy between two VMs will ensure that both VMs will be placed on the same host. A cluster level anti-affinity policy between two VMs will ensure that both VMs will be placed in different clusters. A cluster level affinity policy between two VMs will ensure that both VMs will be placed on a host or hosts in the same cluster. Such affinity and anti-affinity policies may be defined by an administrator/user. When initiated, each fabric component analyzes a list of possible clusters to filter out ineligible clusters of host computers based on client requirements and returns an updated list of possible clusters for the client to be placed, as well as other information, such as resource utilization metrics.

The client placement engine 110 takes the final list of candidate clusters and then ranks the candidate clusters to select the most appropriate cluster or clusters from the candidate clusters to place particular clients. The ranking of the candidate clusters may involve using various information, such as resource utilization metrics provided by the different fabric components, such as CPU, memory and/or network utilization metrics. With the ranked list, the client placement engine will then use the information that affects quality of service of physical interconnectivity in the distributed computer system 100, e.g., the physical network topology, the virtual network topology and the client communication relationships, to try to place clients with actual or expected close communication relationships in one physical network segment or adjacent segments, even when placing the clients in specific virtual networks.

In some embodiments, the client placement engine 110 may also take the parameters of the network links between the physical network segments into account for client placements so that physical network segments with better links between each other are preferred for placement of clients with closer communication relationships, assuming that the clients cannot be placed in the same physical network segment.

As described above, the client placement engine 110 supports both initial client placements and subsequent client placements. An initial client placement occurs when a client is first deployed in the distributed computer system 100. A subsequent client placement occurs when changes in policy or condition of a client or its environment necessitate a new placement location for the client. These condition changes may be changes that violate one or more resource and policy requirements of the client and/or that modify client communication relationships of the client.

In a particular implementation, the client placement engine 100 divides clients to be placed into groups, where the clients in a group have closer communication relationships than clients in different groups. As an example, thresholds for various communication relationship parameters may be used to put the clients into the different groups. These groups can be nested so that some clients belong in multiple groups. For initial client placements, the grouping of clients may be mainly based on expected client communication relationships, which may be provided by a user or creator of the clients. However, when no expected client communication relationship information is provided, the client placement engine may group the clients by virtual network topology or ownership. Examples of such client groups include, but not limited to, (1) clients in the same virtual layer 2 network, (2) clients in virtual layer 2 networks/subnets that are routable between each other, and (3) clients belonging to the same entity, e.g., the same tenant or the same user. For subsequent client placements, the grouping of clients may be based on expected client communication relationships, as well as actual client communication relationships using data collected during runtime. Thus, for subsequent client placements, the clients may be placed in different groups, depending on the actual client communication relationship information.

After the client groups have been defined or modified, the client placement engine 110 attempts to place all or most of the clients in a group into the same physical network segment or adjacent physical network segments. If adjacent physical network segments are being selected, the communication links between the adjacent physical network segments may be considered. The client placement engine may first attempt to place clients in the smallest groups into the smallest physical network segments. If this is not possible, then the client placement engine may attempt to place the clients into the next larger physical network segments, and so on. In this fashion, clients that belong to the same groups will be placed in the same or adjacent physical network segments so that quality of service of physical interconnectivity between the clients in the same group are optimized.

As noted above, in one embodiment, the client placement engine 110 selects the clusters from the list of candidate clusters to place new or existing clients. In this embodiment, once the clusters are selected by the client placement engine, other components in the distributed computer system 100 will select the host computers in the clusters to place the clients. As an example, a VMware vSphere® Distributed Resource Scheduler™ (DRS) managing each of the selected clusters in the distributed computer system may select the host computers in its cluster to place the clients. In other embodiments, the client placement engine may not only select the clusters to place the clients, but also the host computers in the selected clusters to place the clients.

In other embodiments, the client placement engine 110 may only manage one of the clusters in the distributed computer system 100. In these embodiments, there may be multiple client placement engines associated with the clusters to place new or existing clients in their respective clusters. The operation of this cluster-level client placement engine may be similar to the cloud or multicluster-level client placement engine, but limited to the cluster being managed.

In operation, the cluster-level client placement engine 110 attempts to place new or existing clients in the host computers in its cluster so that the virtualized resource and policy requirements can be satisfied and the clients with close communication relationships are placed in the same or adjacent physical network segments. In a particular implementation, the client placement engine divides clients to be placed in its cluster into groups and then attempts to place all or most of the clients in a group into the same physical network segment or adjacent physical network segments within the cluster. The cluster-level process of dividing the clients and placing the clients in each group into the same physical network segment or adjacent physical network segments can be similar to the cloud or multicluster-level process, as described above.

In another embodiment, the cluster-level client placement engine 110 may utilize client-host affinity rules to place new or existing clients with close communication relationships in the same or adjacent physical network segments within the cluster. In this embodiment, the client placement engine operates to define affinity rules that put clients with close communication relationships in a client affinity group and put host computers in one network segment in a host group. The client placement engine would then apply these affinity rules so that the clients with close communication relationships, i.e., a client affinity group, would be placed in the same physical network segment, i.e., a host group. In a particular implementation, the cluster-level client placement engine is part of VMware vSphere® Distributed Resource Scheduler™ (DRS) with VM-host affinity algorithms that are extended to define these modified affinity rules.

In another embodiment, the client placement engine 110 may be implemented at a multi-cluster level and at each cluster level. In this embodiment, the distributed computer system would include a multicluster-level client placement engine and multiple cluster-level placement engines. The multicluster-level client placement engine would select the clusters in the distributed computer system to place new or existing clients. Each of the cluster-level placement engine would then select the host computer or computers in its respective cluster to place the new or existing clients.

When client placement locations, e.g., clusters or host computers, are selected by the client placement engine 110 to place new or existing clients, the client placement locations may be presented to an administrator as recommendations so that the administrator may manually execute the recommended placements. Alternatively, the new or existing clients may be automatically placed in the client placement locations that are selected by the client placement locations. Validation of the recommended placement and the actual execution of the client placements may be performed by other components in the distributed computer system 100.

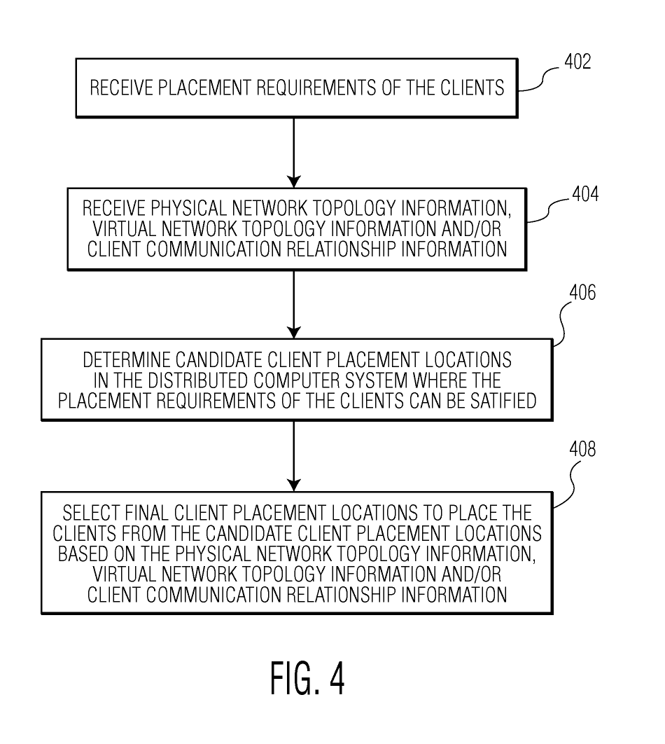

A method for performing automatic placement of clients, e.g., VMs, in a distributed computer system in accordance with an embodiment of the invention is described with reference to a flow diagram of FIG. 4. At block 402, placement requirements of the clients are received at a client placement engine. The placement requirements may include virtualized resource requirements and/or policy requirements of the clients. At block 404, physical network topology information of the distributed computer system, virtual network topology information of the distributed computer system and/or client communication relationship information are received at the client placement engine. At block 406, candidate client placement locations in the distributed computer system where the placement requirements of the clients can be satisfied are determined by the client placement engine. In some embodiments, the candidate client placement locations may be clusters in the distributed computer system. In other embodiments, the candidate client placement locations may be host computers of a particular cluster in the distributed computer system. At block 408, final client placement locations to place the clients are selected from the candidate client placement locations based on the physical network topology information, virtual network topology information and/or client communication relationship information. In some embodiments, the final client placement locations are situated in the same physical network segment or adjacent physical network segments of the distributed computer system.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for performing automatic placement of clients in a distributed computer system, the method comprising:
receiving placement requirements of the clients;
receiving physical network topology information of the distributed computer system;
determining candidate client placement locations in the distributed computer system where the placement requirements of the clients can be satisfied; and
selecting final client placement locations to place the clients from the candidate client placement locations based one at least the physical network topology information of the distributed computer system.

2. The method of claim 1, wherein the selecting the final client placement locations to place the clients includes selecting physical network segments of the distributed computer system to place the clients.

3. The method of claim 2, wherein the physical network segments of the distributed computer system are defined at least partly by communication performance within each of the physical network segments.

4. The method of claim 3, wherein the physical network segments include a single hypervisor segment, a physical virtual local area network segment, a subnet network segment, a subnet group segment or a datacenter segment.

5. The method of claim 2, further comprising receiving virtual network topology information of the distributed computer system, and wherein the selecting the final client placement locations to place the clients includes selecting the final client placement locations to place the clients from the candidate client placement locations based the virtual network topology information of the distributed computer system in addition to the physical network topology information of the distributed computer system.

6. The method of claim 2, further comprising receiving client communication relationship information between at least some of the clients, and wherein the selecting the final client placement locations to place the clients includes recommending to place the clients having client communication relationship in a single physical network segment or adjacent physical network segments of the distributed computer system.

7. The method of claim 6, wherein the client communication relationship information is provided by a user or derived by collecting the client communication relationship information during runtime.

8. The method of claim 1, wherein the receiving the placement requirements of the clients include receiving virtualized resource requirements of the clients.

9. The method of claim 8, wherein the receiving the placement requirements of the clients further include receiving policy requirements of the clients, the policy requirements including at least one affinity or anti-affinity rule.

10. A computer-readable storage medium containing program instructions for automatic placement of clients in a distributed computer system, wherein execution of the program instructions by one or more processors of a computer system causes the one or more processors to perform steps comprising:
receiving placement requirements of the clients;
receiving physical network topology information of the distributed computer system;
determining candidate client placement locations in the distributed computer system where the placement requirements of the clients can be satisfied; and
selecting final client placement locations to place the clients from the candidate client placement locations based on at least the physical network topology information of the distributed computer system.

11. The computer-readable storage medium of claim 10, wherein the selecting the final client placement locations to place the clients includes selecting physical network segments of the distributed computer system to place the clients.

12. The computer-readable storage medium of claim 11, wherein the physical network segments of the distributed computer system are defined at least partly by communication performance within each of the physical network segments.

13. The computer-readable storage medium of claim 12, wherein the physical network segments include a single hypervisor segment, a physical virtual local area network segment, a subnet network segment, a subnet group segment or a datacenter segment.

14. The computer-readable storage medium of claim 11, wherein the steps further comprise receiving virtual network topology information of the distributed computer system, and wherein the selecting the final client placement locations to place the clients includes selecting the final client placement locations to place the clients from the candidate client placement locations based the virtual network topology information of the distributed computer system in addition to the physical network topology information of the distributed computer system.

15. The computer-readable storage medium of claim 11, wherein the steps further comprise receiving client communication relationship information between at least some of the clients, and wherein the selecting the final client placement locations to place the clients includes recommending to place the clients having client communication relationship in a single physical network segment or adjacent physical network segments of the distributed computer system.

16. The method of claim 15, wherein the client communication relationship information is provided by a user or derived by collecting the client communication relationship information during runtime.

17. The computer-readable storage medium of claim 10, wherein the receiving the placement requirements of the clients include receiving virtualized resource requirements of the clients.

18. The computer-readable storage medium of claim 17, wherein the receiving the placement requirements of the clients further includes receiving policy requirements of the clients, the policy requirements including at least one affinity or anti-affinity rule.

19. A management server for a distributed computer system comprising:
a processor; and
a client placement engine that, when executed by the processor, performs steps comprising:
receiving placement requirements of the clients;
receiving physical network topology information of a distributed computer system;
determining candidate client placement locations in the distributed computer system where the placement requirements of the clients can be satisfied; and
selecting final client placement locations to place the clients from the candidate client placement locations based on at least the physical network topology information of the distributed computer system.

20. The distributed computer system server of claim 19, wherein the steps performed by the client placement engine include selecting physical network segments of the distributed computer system to place the clients.

21. The distributed computer system server of claim 20, wherein the physical network segments of the distributed computer system are defined at least partly by communication performance within each of the physical network segments.

22. The distributed computer system server of claim 21, wherein the physical network segments include a single hypervisor segment, a physical virtual local area network segment, a subnet network segment, a subnet group segment or a datacenter segment.

23. The distributed computer system server of claim 20, wherein the steps performed by the client placement engine comprise receiving virtual network topology information of the distributed computer system and selecting the final client placement locations to place the clients from the candidate client placement locations based the virtual network topology information of the distributed computer system in addition to the physical network topology information of the distributed computer system.

24. The distributed computer system server of claim 20, wherein the steps performed by the client placement engine include receiving client communication relationship information between at least some of the clients and recommending to place the clients having client communication relationship in a single physical network segment or adjacent physical network segments of the distributed computer system.

25. The distributed computer system server of claim 24, wherein the client communication relationship information is provided by a user or derived by collecting the client communication relationship information during runtime.
